(19) United States
(12) Patent Application Publication
(10) Pub. No.: US 2009/0271195 A1
(43) Pub. Date: Oct. 29, 2009

(54) SPEECH RECOGNITION APPARATUS, SPEECH RECOGNITION METHOD, AND SPEECH RECOGNITION PROGRAM

(75) Inventors: Tasuku Kitade, Tokyo (JP); Takafumi Koshinaka, Tokyo (JP)

Correspondence Address: DICKSTEIN SHAPIRO LLP, 1633 Broadway, NEW YORK, NY, 10019, US

(73) Assignee: NEC Corporation, Tokyo (JP)

(21) Appl. No.: 12/307,736

(22) PCT Filed: Jul. 6, 2007
(86) PCT No.: PCT/JP2007/063580

§ 371 Date: Jan. 6, 2009

(30) Foreign Application Priority Data
Jul. 7, 2006 (JP) 2006-187951

(51) Int. Cl. G10L 15/06; G10L 15/18

(52) U.S. Cl. 704/239; 704/257; 704/243; 704/E15.018; 704/E15.015

(57) ABSTRACT

A speech recognition apparatus capable of attaining high recognition accuracy within practical processing time using a computing machine having standard performance by appropriately adapting a language model to a speech about a certain topic, irrespectively of a degree of detail and diversity of the topic and irrespectively of a confidence score of an initial speech recognition result is provided. The speech recognition apparatus includes hierarchical language model storage means for storing a plurality of language models structured hierarchically, text-model similarity calculation means for calculating a similarity between a tentative recognition result for an input speech and each of the language models, recognition result confidence score calculation means for calculating a confidence score of the recognition result, topic estimation means for selecting at least one of the language models based on the similarity, the confidence score, and a depth of a hierarchy to which each of the language models belongs, and topic adaptation means for mixing up the language models selected by the topic estimation means, and for creating one language model.

### TECHNICAL FIELD

This application is based upon and claims the benefit of priority from Japanese patent application No. 2006-187951, filed on Jul. 7, 2006, the disclosure of which is incorporated herein in its entirety by reference.

The present invention relates to a speech recognition apparatus, a speech recognition method, and a speech recognition program. The present invention particularly relates to a speech recognition apparatus, a speech recognition method, and a speech recognition program for performing a speech recognition using a language model adapted according to contents of a topic to which an input speech belongs.

### BACKGROUND ART

An example of a speech recognition apparatus related to the present invention is described in Patent Document 1. As shown in FIG. 2, the speech recognition apparatus related to the present invention is configured to include speech input means 901, acoustic analysis means 902, a syllable recognition means (first stage recognition) 904, topic change candidate point setting means 905, language model setting means 906, word sequence search means (second stage recognition) 907, acoustic model storage means 903, differential model 908, language model 1 storage means 909-1, language model 2 storage means 909-2, . . . , and language model n storage means 909-n.

The speech recognition apparatus related to the present invention and configured as stated above operates as follows.

Namely, language models corresponding to different topics are stored in respective language model k storage means 909-k (k=1, . . . , n), the language models stored in the language model k storage means 909-k (k=1, . . . , n) are applied to respective parts of an input speech, the word sequence search means 907 searches n word sequences, selects a word sequence having a highest score, and sets the selected word sequence as a final recognition result.

Furthermore, another example of the speech recognition apparatus related to the present invention is described in Non-Patent Document 1. As shown in FIG. 3, the speech recognition apparatus related to the present invention is configured to include acoustic analysis means 31, word sequence search means 32, language model mixing means 33, and language model storage means 341, 342, . . . , and 34n. The speech recognition apparatus related to the present invention and configured as stated above operates as follows.

Namely, language models corresponding to different topics are stored in language model k storage means 341, 342, . . . , and 34n, respectively. The language model mixing means 33 mixes up the n language models to create one language model based on a mixture ratio calculated by a predetermined algorithm, and transmits the language model to the word sequence search means 32. The word sequence search means 32 receives one language model from the language model mixing means 33, searches a word sequence corresponding to an input speech signal and outputs the word sequence as a recognition result. Further, the word sequence search means 32 transmits the word sequence to the language model mixing means 33 and the language model mixing means 33 measures similarities between the language models stored in the respective language model storage means 341, 342, . . . , and 34n and the word sequence, and updates a value of the mixture ratio so that the mixture ratio for the language models having high similarities is high and so that the mixture ratio for the language models having low similarities is low.

Moreover, yet another example of the speech recognition apparatus related to the present invention is described in Patent Document 2. As shown in FIG. 4, the speech recognition apparatus related to the present invention is configured to include a topic-independent speech recognition 220, a topic detection 222, a topic-specific speech recognition 224, a topic-specific speech recognition 226, a selection 228, a selection 232, a selection 234, a selection 236, a selection 240, a topic storage 230, a topic comparison 238, and a hierarchical language model 40.

The speech recognition apparatus related to the present invention and configured as stated above operates as follows.

Namely, the hierarchical language model 40 includes a plurality of language models of a hierarchical structure as shown in FIG. 5. The topic-independent speech recognition 220 performs a speech recognition while referring to a topic-independent language model 70 located at a root node of the hierarchical structure, and outputs a word sequence as a recognition result. The topic detection 222 selects one of topic-specific language models 100 to 122 located at respective leaf nodes of the hierarchical structure based on the word sequence as a first stage recognition result. The topic-specific speech recognition 224 refers to the topic-specific language model selected by the topic detection 222 and to a language model corresponding to a parent node of the selected topic-specific language model, performs speech recognitions on the both language models independently, calculates word sequences as recognition results, compares the both word sequences, selects one language model having a higher score, and outputs the selected language model. The selection 234 compares the recognition result output from the topic-independent speech recognition 220 with that output from the topic-specific speech recognition 224, selects one language model having a higher score, and outputs the selected language model.

Patent Document 1: JP-A-No. 2002-229589

Patent Document 2: JP-A-No. 2004-198597

Patent Document 3: JP-A-No. 2002-091484

Non-Patent Document 1: Mishina and Yamamoto: “Context adaptation using variational Bayesian learning for ngram models based on probabilistic LSA” TECHNICAL REPORT OF IEICE, Vol. J87-D-II, Seventh Issue, July 2004, pp. 1409-1417.

### DISCLOSURE OF THE INVENTION

### Problems to be Solved by the Invention

A first problem is as follows. If the speech recognition is independently performed while referring to all of a plurality of language models prepared for respective topics, the recognition result cannot be obtained within practical processing time using a calculating machine having standard performance.

The reason for the first problem is that the number of speech recognition processings increases proportionally to the number of types of topics, i.e., the number of language models in the speech recognition apparatus related to the present invention and described in the Patent Document 1.

A second problem is as follows. If only the language model related to a specific topic is selected according to an input speech, the topic cannot be accurately estimated depending on a content of the topic included in the input speech. In that case, language model adaptation fails, resulting in incapability to ensure high recognition accuracy.

The reason for the second problem is that the topic, that is, a content of sentences cannot be normally decided definitively. Namely, the topic contains vagueness. Furthermore, as topics include general topics and special topics, range of topics may possibly be various levels.

For example, if a language model related to a global politics related topic and a language model related to a sports related topic are present, it is generally possible to estimate a topic from speech about global politics and speech about sports. However, such a topic as “the Olympics are boycotted because of deteriorated political situations among the states” involves both the global politics related topic and the sports related topic. A speech about such a topic is located at a far position from both of the language models, with the result that the topic is often misestimated.

The speech recognition apparatus related to the present invention and described in the Patent Document 2 selects one language model from among the language models located at the leaf nodes of the hierarchical structure, that is, those created at most detailed topical levels. Due to this, the above-stated misestimation of the topic often occurs.

Furthermore, the speech recognition apparatus related to the present invention and described in the Non-Patent Document 1 mixes up a plurality of language models at a predetermined mixture ratio according to a scheme such as maximum likelihood estimation. However, because it is theoretically assumed that one input speech includes only one topic (single topic), there is a limit to how to deal with an input involving a plurality of topics (multiple topics).

Moreover, it is difficult for the speech recognition apparatus related to the present invention to accurately estimate a topic if a level of a degree of detail of the topic differs from an estimated one. For example, a topic related to “the Iraqi War” is generally contained in topics related to “Middle East situations”. In this case, if a language model equal to the level of the degree of detail of “the Iraqi War” is present and a speech about the “Middle East situations” that is a wider topic than the Iraqi War is input, then a distance between the input speech and the language model is far and it is, therefore, difficult to estimate the topic. Conversely, if a language model corresponding to a wide topic is present and a speech about a narrow topic is input, the same problem occurs.

A third problem is as follows. If only a language model related to a specific topic is selectively used according to an input speech, and an initial recognition result based on which a judgment is made at the time of estimating a topic of the input speech includes many misrecognitions, the topic cannot be accurately estimated. As a result, language model adaptation fails and high recognition accuracy cannot be obtained.

The reason for the third problem is that if the initial recognition result includes many misrecognitions, then words irrelevant to an original topic frequently appear and hamper accurate estimation of the topic.

An exemplary object of the present invention is to provide a speech recognition apparatus capable of attaining high recognition accuracy within practical processing time using a computing machine having a standard performance by appropriately adapting a language model for a speech about a certain content whether the content include only a single topic or multiple topics and whether how a level of a degree of detail of the topic is or even if confidence score of a recognition result is low.

### Means for Solving the Problems

According to a first exemplary aspect of the present invention, there is provided a speech recognition apparatus includes hierarchical language model storage means for storing a plurality of language models structured hierarchically, text-model similarity calculation means for calculating a similarity between a tentative recognition result for an input speech and each of the language models, recognition result confidence score calculation means for calculating a confidence score of the recognition result, topic estimation means for selecting at least one of the language models based on the similarity, the confidence score, and a depth of a hierarchy to which each of the language models belongs, and topic adaptation means for mixing up the language models selected by the topic estimation means, and for creating one language model.

### ADVANTAGES OF THE INVENTION

A hand scanner according to the present invention scans a target using a one-dimensional image sensor through an oblique optical axis from an upper portion of a housing. Due to this, a field of vision of the sensor, that is, an input position can be always observed and checked either directly or in the neighborhood. It is, therefore, advantageously possible to selectively use one of left and right side ends according to a filing condition for an input target or an operation method.

### BRIEF DESCRIPTION OF THE DRAWINGS

FIG. 1 is a block diagram showing a configuration of a best mode for carrying out a first exemplary invention of the present invention;

FIG. 2 is a block diagram showing a configuration of an example of a technique related to the present invention;

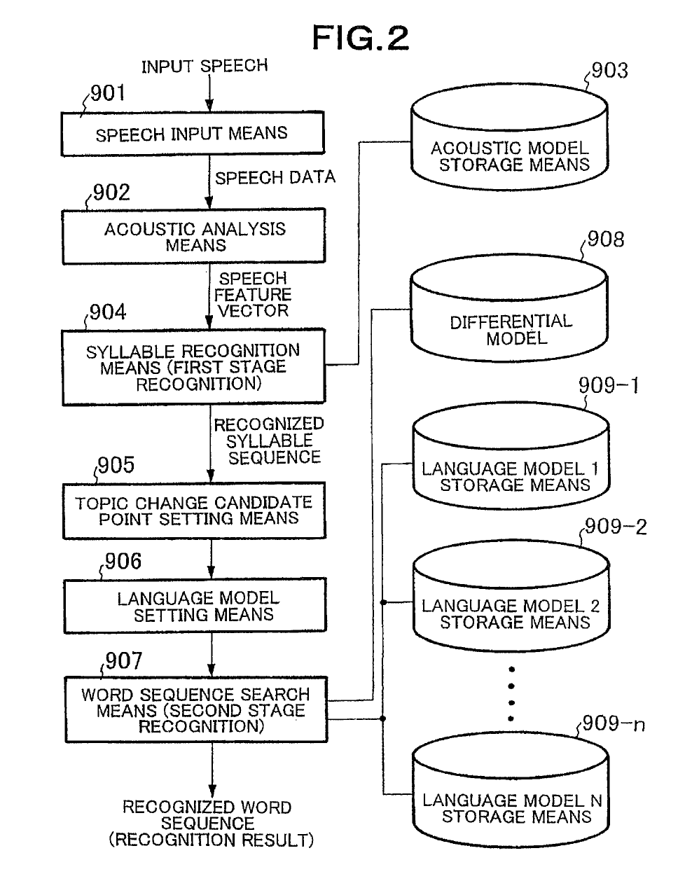

FIG. 3 is a block diagram showing a configuration of an example of a technique related to the present invention;

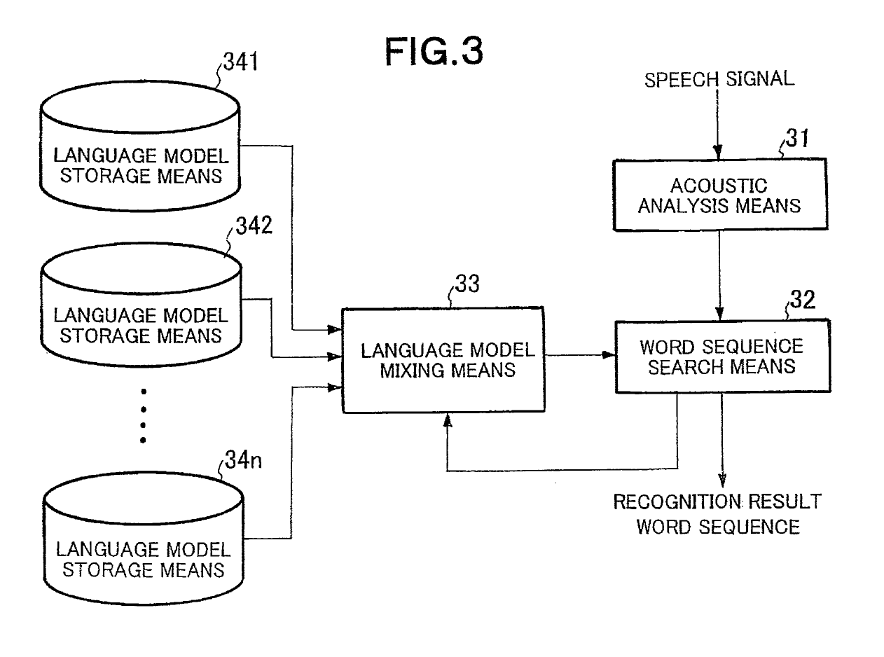

FIG. 4 is a block diagram showing a configuration of an example of a technique related to the present invention;

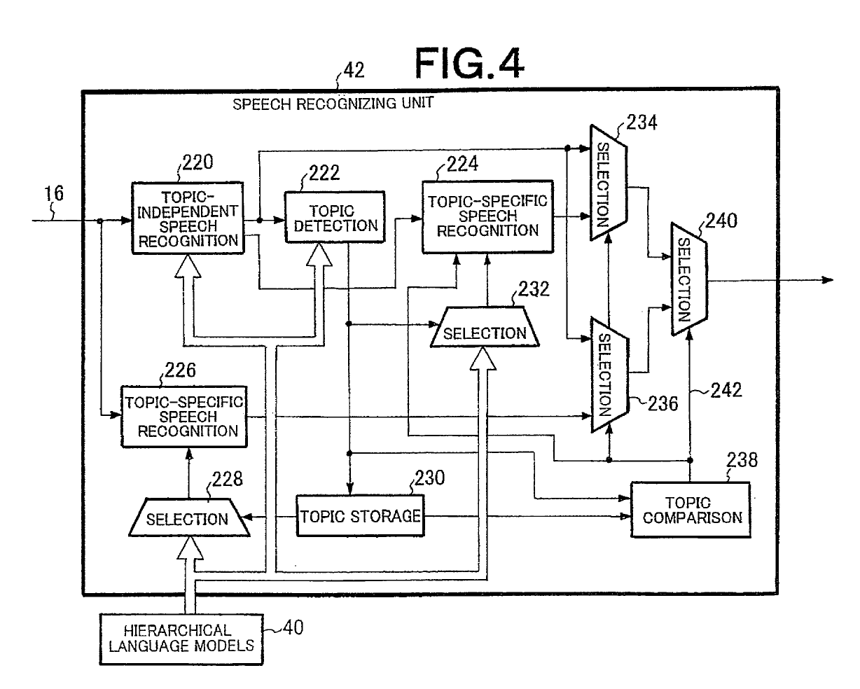

FIG. 5 is a block diagram showing a configuration of an example of a technique related to the present invention;

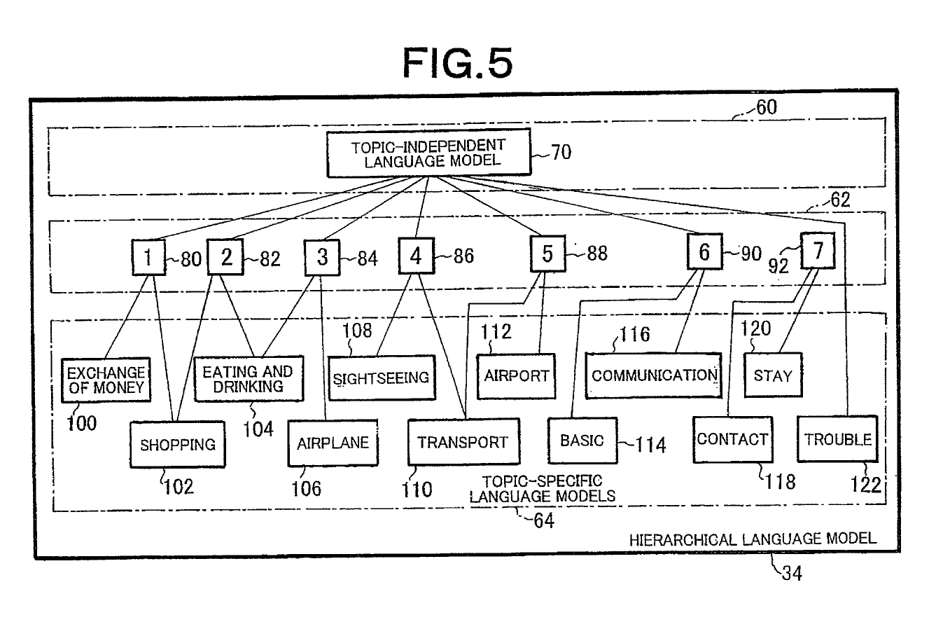

FIG. 6 is a block diagram showing a configuration of the best mode for carrying out the first exemplary invention of the present invention;

FIG. 7 is a flowchart showing an operation in the best mode for carrying out the first exemplary invention of the present invention; and

FIG. 8 is a block diagram showing a configuration of the best mode for carrying out a second exemplary invention of the present invention.

### DESCRIPTION OF REFERENCE SYMBOLS

11 first speech recognition means
12 recognition result confidence score calculation means
13 text-model similarity calculation means
14 model-model similarity calculation means
15 hierarchical language model storage means
16 topic estimation means
17 topic adaptation means
18 second speech recognition means
31 acoustic analysis means
32 word sequence search means
33 language model mixing means
341 language model storage means
342 language model storage means
34n language model storage means
1500 topic-independent language model
1501-1518 topic-specific language model
81 input device
82 speech recognition program
83 data processing device
84 storage device
840 hierarchical language model storage unit
842 model-model similarity storage unit
A1 read speech signal
A2 read topic-independent language model
A3 calculate tentative recognition result
A4 calculate recognition result confidence score
A5 calculate recognition result-language model similarity
A6 select language models
A7 mix up language models
A8 calculate final recognition result

### BEST MODE FOR CARRYING OUT THE INVENTION

An exemplary best mode for carrying out the present invention will be described hereinafter in detail with reference to the drawings.

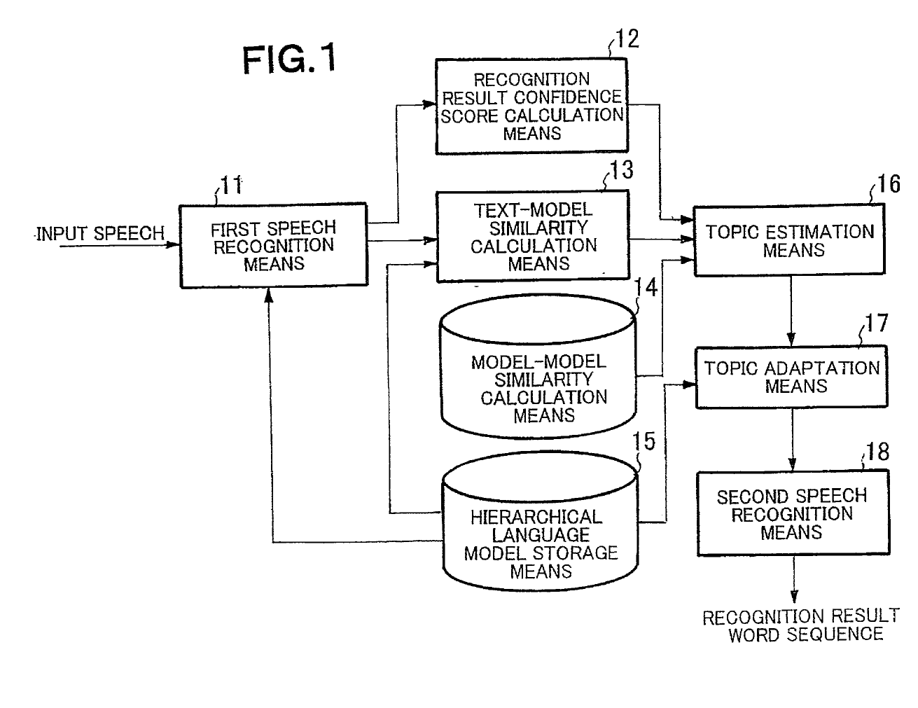

A speech recognition apparatus according to the present invention is configured to include hierarchical language model storage means (15 in FIG. 1) storing therein a graph structure hierarchically expressing topics according to types and degrees of detail of the topics and language models associated with respective nodes of a graph, first speech recognition means (11 in FIG. 1) calculating a tentative recognition result for estimating a topic to which an input speech belongs, recognition result confidence score calculation means (12 in FIG. 1) calculating a confidence score indicating a degree of a correctness of the tentative recognition result, text-model similarity calculation means (13 in FIG. 1) calculating a similarity between the tentative recognition result and each of the language models stored in the hierarchical language model storage means, model-model similarity storage means (14 in FIG. 1) storing language model-language model similarities for the respective language models stored in the hierarchical language model storage means, topic estimation means (16 in FIG. 1) selecting at least one of the language models corresponding to the topic included in the input speech from the hierarchical language model storage means using the confidence score and the similarities obtained from the recognition result confidence score calculation means, the text-model similarity calculation means, and the model-model similarity calculation means, respectively, topic adaptation means (17 in FIG. 1) mixing up the language models selected by the topic estimation means and creating one language model, and second speech recognition means performing a speech recognition while referring to the language model created by the topic adaptation means, and outputting a recognition result word sequence. The speech recognition apparatus operates so as to create one language model adapted to a content of the topic included in the input speech in consideration of a content of the tentative recognition result, the confidence score, and the relations between the prepared language models. By adopting such a configuration and performing the speech recognition on the language models adapted to the content of the topic of the input speech, it is possible to attain the object of the present invention.

Referring to FIG. 1, a first embodiment of the present invention is configured to include the first speech recognition means 11, the recognition result confidence score calculation means 12, the text-model similarity calculation means 13, the model-model similarity calculation means 14, the hierarchical language model storage means 15, the topic estimation means 16, the topic adaptation means 17, and the second speech recognition means 18.

These means generally operate as follows.

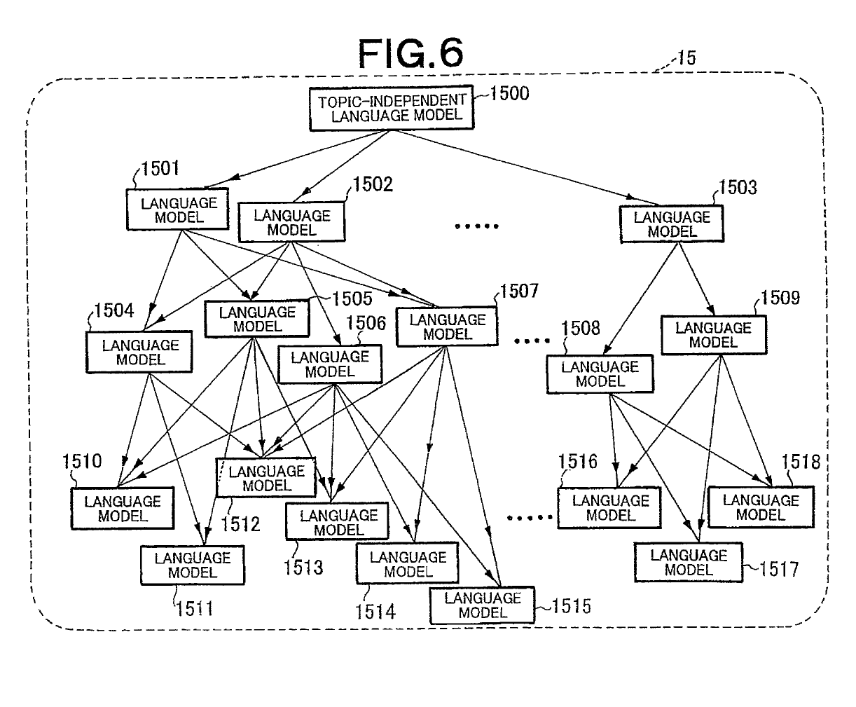

The hierarchical language model storage means 15 stores therein topic-specific language models structured hierarchically according to the types and degrees of detail of topics. FIG. 6 is a diagram conceptually showing an example of the hierarchical language model storage means 15. Namely, the hierarchical language model storage means 15 includes language models 1500 to 1518 corresponding to various topics. Each of the language models is a well-known N-gram language model or the like. These language models are located in higher or lower hierarchies according to the degrees of detail of the topics. In FIG. 6, the language models connected by an arrow hold a relationship of a higher conception (a start of the arrow) and a lower conception (an end of the arrow) in relation to a topic such as “Middle East situations” or “the Iraqi War” stated above. The language models connected by the arrow may be accompanied by a similarity or a distance under some mathematical definition as will be described later with reference to the model-model similarity storage means 14. It is to be noted that the language model 1500 located in a highest hierarchy is a language model covering a widest topic and particularly referred to as “topic-independent language model” herein.

The language models included in the hierarchical language model storage means 15 are created from language model training text corpus prepared in advance. As a creation method, a method including sequentially dividing the corpus into segments by tree structure clustering, and training language models according to divided units as described in, for example, the Patent Document 3, a method including dividing the corpus according to several degrees of detail using a probabilistic LSA, and training language models according to divided units (clusters) as described in the Non-Patent Document 1 or the like can be used. The topic-independent language model stated above is a language model trained using the entire corpus.

The model-model similarity storage means 14 stores therein a value of the similarity or distance between the language models located in the hierarchically higher and lower relationship among those stored in the hierarchical language model storage means 15. As definition of the similarity or distance, a Kullback-Leibler divergence or mutual information, a perplexity or normalized cross perplexity described in the Patent Document 2, for example, may be used as the distance, or a sign-inverted normalized cross perplexity or a reciprocal of the normalized cross perplexity may be defined as the similarity.

The first speech recognition means 11 calculates a word sequence as a tentative recognition result for estimating a topic included in a produced content of an input speech using an appropriate language model, e.g., the topic-independent language model 1500 stored in the hierarchical language model storage means 15.

The first speech recognition means 11 includes inside well-known means necessary for a speech recognition such as acoustic analysis means extracting an acoustic features from the input speech, word sequence search means searching a word sequence making a best match with the acoustic features, and acoustic model storage means storing therein a standard pattern of the acoustic features, i.e., an acoustic model for each recognition unit such as a phoneme.

The recognition result confidence score calculation means 12 calculates a confidence score indicating a reliability of correctness of the recognition result output from the first speech recognition means 11. As definition of the confidence score, anything that reflects the reliability of correctness of the entire word sequence as the recognition result, i.e., a recognition rate can be used. For example, the confidence score may be a score obtained by multiplying each of an acoustic score and a language score calculated together with the word sequence as the recognition result by the first speech recognition means 11 by a predetermined weighting factor and adding together the weighted acoustic score and the weighted language score. Alternatively, if the first recognition means 11 can output a recognition result (N best recognition result) including not only a top recognition result but also top N recognition results or a language graph containing the N best recognition results, the confidence score can be defined as an appropriately normalized quantity so as to be able to interpret the above-stated score as a probabilistic value.

The text-model similarity calculation means 13 calculates a similarity between the recognition result (text) output from the first speech recognition means 11 and each of the language models stored in the hierarchical language model storage means 15. The definition of the similarity is similar to that of the similarity defined between the language models by the model-model similarity storage means 14 above-stated. The perplexity or the like may be defined as the distance and a sign-inverted distance or a reciprocal thereof may be defined as the similarity.

The topic estimation means 16 receives outputs from the recognition result calculation means 12 and the text-model similarity calculation means 13 while, if necessary, referring to the model-model similarity storage means 14, estimates the topic included in the input speech, and selects at least one language model corresponding to the topic from the hierarchical language model storage means 15. In other words, the topic estimation means 16 selects i satisfying a certain condition, where i is an index uniquely identifying each language model.

A selection method will be described specifically. If the similarity between the recognition result output from the text-model similarity calculation means 13 and a language model i is S1(i), the similarity between language models i and j stored in the model-model similarity storage means 14 is S2(i, j), a depth of a hierarchy of the language model i is D(i), and the confidence score output from the recognition result confidence score calculation means 12 is C, then the following conditions are set, for example.

Condition 1: S1(i)>T1

Condition 2: D(i)<T2(C)

Condition 3: S2(i, j)>T3.

In the conditions 1 to 3, T1 and T3 are preset thresholds and T2(C) is a threshold decided depending on the confidence score C. It is preferable that the conditions 1 to 3 are a monotonous increasing function (e.g., a relatively low-order polynomial function or exponential function) so that T2(C) is greater if the confidence score C is higher. Using the above-stated conditions, the language model is selected according to the following rules.

1. Select all language models i satisfying the conditions 1 and 2.

2. Select language models j satisfying the conditions 3 from among higher or lower hierarchies than that of the language models i in relation to the language models i selected in the previous section.

The conditions 1, 2, and 3 mean as follows. The condition 1 means that the language model i includes a topic close to the recognition result. The condition 2 means that the language model i is similar to the topic-independent language model, that is, includes a wide topic. The condition 3 means that the language model j includes a topic similar to the language model i (satisfying the conditions 1 and 2).

In the conditions 1 and 3, S1(i) and S₂(i, j) are values calculated by the text-model similarity calculation means 13 and the model-model similarity calculation means 14, respectively. The depth D(i) of a hierarchy can be given as a simple natural number, for example, a depth of the highest hierarchy (topic-independent language model) is 0 and that of a hierarchy right under the highest hierarchy is 1. Alternatively, the depth D(i) of a hierarchy can be given as a real value such as D(i)=S₂(0, i) using the language model-language model similarities stored in the model-model similarity storage means 14. It is to be noted that an index of the topic-independent language model is 0. Moreover, if a hierarchy to which the language model i belongs separates from that of the topic-independent language model and the value of S₂(0, i) is not stored in the model-model similarity storage means 14, the depth D(i) of a hierarchy can be calculated by adding up language model-language model similarities between sufficiently close hierarchies such as adjacent hierarchies.

As for the condition 1, the threshold T1 on a right-hand side may be changed according to the language model used in the first speech recognition means 11. Namely, a condition 1′: S1(i)>Ti(i, i0), where i0 is an index identifying the language model used in the first speech recognition means 11, and T1 (i, i0) is decided as, for example, T1(i, i0)=ρ×S2(i, i0)+μ, from the similarity between the language model of interest and the language model used in the first speech recognition means 11. Symbol ρ is a positive constant. In this manner, by controlling the threshold T1, it is possible to reduce a tendency that the topic estimation means 16 selects a language model i0 or a model closer to the model i0 irrespectively of the content of the input speech.

The topic adaptation means 17 mixes up the language models selected by the topic estimation means 16 and creates one language model. As a mixing method, a linear coupling method, for example, may be used. As a mixture ratio during the mixing, the created language model may simply be a result of equidistribution of the respective language models. Namely, a reciprocal of the number of mixed language models may be set as a mixture coefficient. Alternatively, such a method of setting a mixture ratio for the language models selected primarily in the conditions 1 and 2 higher and setting that for the language models selected secondarily in the condition 3 lower may be considered.

It is to be noted that the topic estimation means 16 and the topic adaptation means 17 may operate differently. In the above-stated mode, the topic estimation means 16 operates to output a discrete (binary) result of selection/non-selection of language models. Alternatively, the topic estimation means 16 may operate to output a continuous result (real value). As a specific example, the topic estimation means 16 may calculate a value of wᵢ in Equations (1) for linearly coupling conditional expressions of the above-stated conditions 1 to 3 and output the value of wᵢ. The language models are selected by multiplying a threshold determination w>w₀ by the value of wᵢ.

$${u}_{i} = α \{ {S}_{1} ( i ) - {T}_{1} \} + β \{ {T}_{2} ( C ) - D ( i ) \} \\ {w}_{i} = {u}_{i} + γ {\sum }_{j \neq i , {u}_{j} > 0} \{ {S}_{2} ( i , j ) - {T}_{3} \} \qquad ( 1 )$$

In the Equations (1), α, β, and γ are positive constants. In response to the wᵢ output from the topic estimation means 16 as stated above, the topic adaptation means 17 uses the wᵢ as the mixture ratio during mixture of the language models. Namely, the language model is created according to Equation (2).

$$P ( t \vert h ) = \frac{{\sum }_{{w}_{i} > {w}_{0}} {w}_{i} {P}_{i} ( t \vert h )}{{\sum }_{{w}_{i} > {w}_{0}} {w}_{i}} \qquad ( 2 )$$

In the Equation (2), P(t|h) on a left-hand side is a general expression of an N-gram language model, indicates a probability that a word t appears if a word history h just before the word t is a condition, and corresponds herein to a language model referred to by the second speech recognition means 18. Further, Pᵢ(t|h) on a right-hand side has a similar meaning to the meaning of P(t|h) on the left-hand side and corresponds to an individual language model stored in the hierarchical language model storage means 15. Symbol wₒ is a threshold for language model selection made by the above-stated topic estimation means 16.

Similarly to a right-hand side of the condition 1′, T1 in the Equations (1) can be changed according to the language model used in the first speech recognition means 11, that is, set to T1 (i, i0).

The second speech recognition means 18 performs a speech recognition on the input speech similarly to the first speech recognition means 11 while referring to the language model created by the topic adaptation means 17, and outputs an obtained word sequence as a final recognition result.

In the embodiment, the speech recognition apparatus may be configured to include common means that functions as both the first speech recognition means 11 and the second speech recognition means 18 instead of a configuration in which the first speech recognition means 11 and the second speech recognition means 18 are separately provided. In that case, the speech recognition apparatus operates so that language models are adapted sequentially to sequentially input speech signals online. Namely, if an input speech is one certain sentence, one certain composition or the like, the recognition result confidence score calculation means 12, the text-model similarity calculation means 13, the topic estimation means 16, and the topic adaptation means 17 create language models while referring to the model-model similarity storage means 14 and the hierarchical language model storage means 15 based on the recognition result output from the second speech recognition means 18. The second speech recognition means 18 performs speech recognition on a subsequent sentence, composition or the like while referring to the created language model and outputs a recognition result. The above-stated operations are repeated until the end of the input speech.

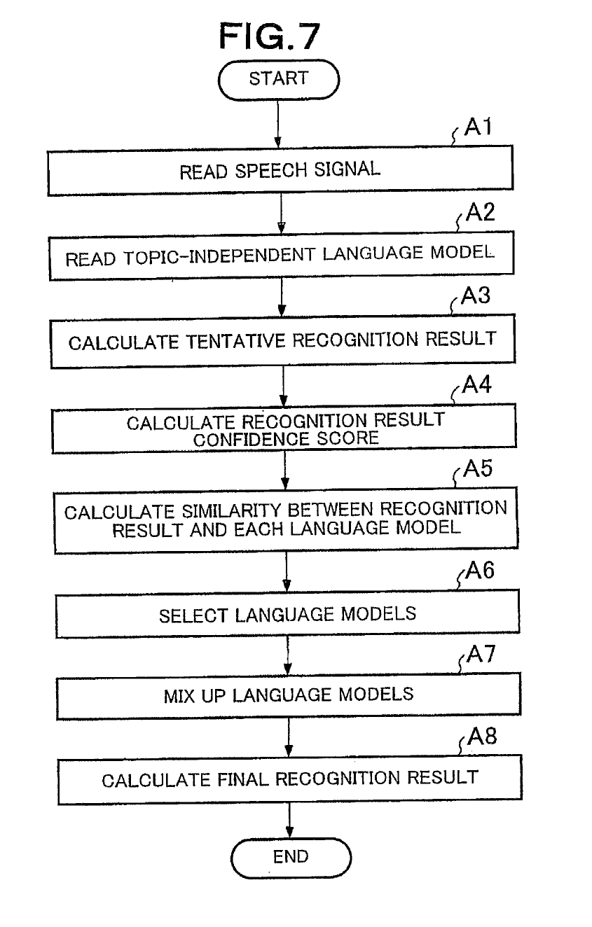

Overall operation according to the embodiment will next be described in detail with reference to FIG. 1 and the flowchart of FIG. 7.

First, the first speech recognition means 11 reads an input speech (step A1 in FIG. 7), reads one of the language models or preferably the topic-independent language model (1500 in FIG. 6) stored in the hierarchical language model storage mean 15 (step A2), reads an acoustic model, not shown, and calculates a word sequence as a tentative speech recognition result (step A3). Next, the recognition result confidence score calculation means 12 calculates the confidence score of the recognition result from the tentative speech recognition result (step A4). The text-model similarity calculation means 13 calculates a similarity between each of the language models stored in the hierarchical language mode storage means 15 and the tentative recognition result (step A5). Furthermore, the topic estimation means 16 selects at least one language model from among the language models stored in the hierarchical language model storage means 15 or sets weighting factors to the respective language models based on the above-stated rules while referring to the confidence score of the recognition result, the similarity between each language model and the tentative recognition result, and the language model-language model similarities stored in the model-model similarity storage means 14 (step A6). Thereafter, the topic adaptation means 17 mixes up the language models which are selected and to which the weighting factors are set, respectively, and creates one language model (step A7). Finally, the second speech recognition means 18 performs a speech recognition similarly to the first speech recognition means 11 using the language model created by the topic adaptation means 17, and outputs an obtained word sequence as a final recognition result (step A8).

It is to be noted that an order of the steps A1 and A2 can be changed. Moreover, if it is known that speech signals are repeatedly input, it suffices to read the language model (step A2) only once before reading the first speech signal (step A1). An order of the steps A4 and A5 can be also changed.

Advantages of the embodiment of the present invention will next be described.

In the embodiment, the speech recognition apparatus is configured to select and mixes up language models from among those hierarchically structured according to the types and degrees of detail of the topics in view of the language model-language model relationships and the confidence score of the tentative recognition result, and to perform speech recognition adapted to the topic of the input speech using the created language model. Due to this, even if the content of the input speech involves a plurality of topics, even if the level of the degree of detail of the topic is changed or even if the tentative recognition result includes many errors, it is possible to obtain a highly accurate recognition result within practical processing time using a standard computing machine.

Next, a best mode for carrying out a second exemplary invention of the present invention will be described in detail with reference to the drawings.

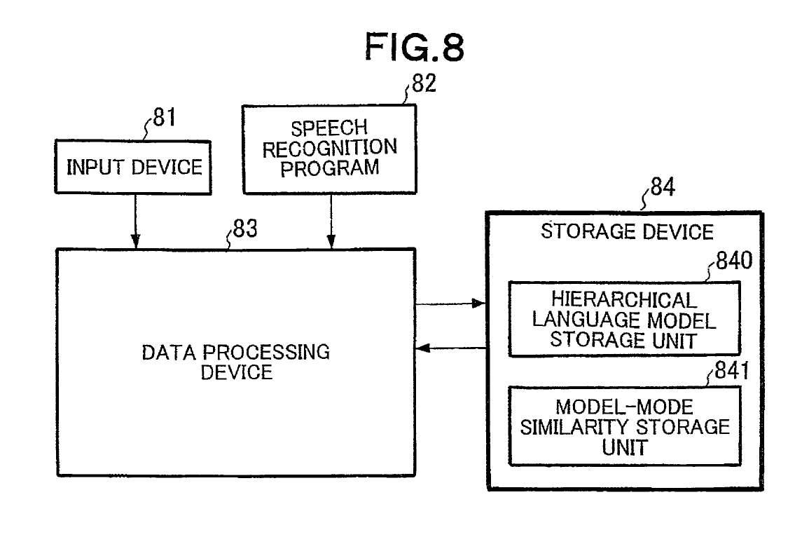

Referring to FIG. 8, the best mode for carrying out the second exemplary invention of the present invention is a block diagram of a computer actuated by a program if the best mode for carrying out the first invention is constituted by the program.

The program is read by a data processing device 83 to control operation performed by the data processing device 83. The data processing device 83 performs the following processings, controlled by the speech recognition program 82, i.e., the same processings as those performed by the first speech recognition means 11, the recognition result confidence score calculation means 12, the text-model similarity calculation means 13, the topic estimation means 16, the topic adaptation means 17, and the second speech recognition means 18 according to the first embodiment, on a speech signal input from an input device 81.

According to a second exemplary aspect of the present invention, there is provided a speech recognition apparatus comprising: hierarchical language model storage means for storing a plurality of language models structured hierarchically; text-model similarity calculation means for calculating a similarity between a tentative recognition result for an input speech and each of the language models; model-model similarity storage means for storing a language model-language model similarities for the respective language models; topic estimation means for selecting at least one of the hierarchical language models based on the similarity between the tentative recognition result and each of the language models, the language model-language model similarities, and a depth of a hierarchy to which each of the language models belongs; and topic adaptation means for mixing up the language models selected by the topic estimation means, and for creating one language model.

According to a third exemplary aspect of the present invention, there is provided a speech recognition method comprising: a referring step of referring to hierarchical language model storage means for storing a plurality of language models structured hierarchically; a text-model similarity calculation step of calculating a similarity between a tentative recognition result for an input speech and each of the language models; a recognition result confidence score calculation step of calculating a confidence score of the recognition result; a topic estimation step of selecting at least one of the language models based on the similarity, the confidence score, and a depth of a hierarchy to which each of the language models belongs; and a topic adaptation step of mixing up the language models selected at the topic estimation step, and of creating one language model.

According to a fourth exemplary aspect of the present invention, there is provided a speech recognition method comprising: a hierarchical language model storage step of storing a plurality of language models structured hierarchically; a text-model similarity calculation step of calculating a similarity between a tentative recognition result for an input speech and each of the language models; a model-model similarity storage step of storing a language model-language model similarities for the respective language models; a topic estimation step of selecting at least one of the hierarchical language models based on the similarity between the tentative recognition result and each of the language models, the language model-language model similarities, and a depth of a hierarchy to which each of the language models belongs; and a topic adaptation step of mixing up the language models selected at the topic estimation step, and of creating one language model.

According to a fifth exemplary aspect of the present invention, there is provided a speech recognition program for causing a computer to execute a speech recognition method comprising: a referring step of referring to hierarchical language model storage means for storing a plurality of language models structured hierarchically; a text-model similarity calculation step of calculating a similarity between a tentative recognition result for an input speech and each of the language models; a recognition result confidence score calculation step of calculating a confidence score of the recognition result; a topic estimation step of selecting at least one of the language models based on the similarity, the confidence score, and a depth of a hierarchy to which each of the language models belongs; and a topic adaptation step of mixing up the language models selected at the topic estimation step, and of creating one language model.

According to a sixth exemplary aspect of the present invention, there is provided a speech recognition program for causing a computer to execute a speech recognition method comprising: a hierarchical language model storage step of storing a plurality of language models structured hierarchically; a text-model similarity calculation step of calculating a similarity between a tentative recognition result for an input speech and each of the language models; a model-model similarity storage step of storing a language model-language model similarities for the respective language models; a topic estimation step of selecting at least one of the hierarchical language models based on the similarity between the tentative recognition result and each of the language models, the language model-language model similarities, and a depth of a hierarchy to which each of the language models belongs; and a topic adaptation step of mixing up the language models selected at the topic estimation step, and of creating one language model.

Although the exemplary embodiments of the present invention have been described in detail, it should be understood that various changes, substitutions and alternatives can be made therein without departing from the sprit and scope of the invention as defined by the appended claims. Further, it is the inventor's intent to retain all equivalents of the claimed invention even if the claims are amended during prosecution.

### INDUSTRIAL APPLICABILITY

The present invention is applicable to such uses as a speech recognition apparatus for converting a speech signal into a text and a program for realizing a speech recognition apparatus in a computer. Furthermore, the present invention is applicable to such uses as an information search apparatus for conducting various information searches using an input speech as a key, a content search apparatus for automatically allocating a text index to each of video contents each accompanied by a speech and that can search the video contents, and a supporting apparatus for typing recorded speech data.

1. A speech recognition apparatus comprising:
hierarchical language model storage means for storing a plurality of language models structured hierarchically;
text-model similarity calculation means for calculating a similarity between a tentative recognition result for an input speech and each of the language models;
recognition result confidence score calculation means for calculating a confidence score of the recognition result;
topic estimation means for selecting at least one of the language models based on the similarity, the confidence score, and a depth of a hierarchy to which each of the language models belongs; and
topic adaptation means for mixing up the language models selected by the topic estimation means, and for creating one language model.

2. The speech recognition apparatus according to claim 1,
wherein the topic estimation means selects the language models based on a threshold determination in respect of the similarity, the confidence score, and the depth of each hierarchy.

3. The speech recognition apparatus according to claim 1,
wherein the topic estimation means selects the language models based on a threshold determination in respect of a linear sum of the similarity, a function of the confidence score, and a function of the depth of each hierarchy of a topic.

4. The speech recognition apparatus according to claim 1, further comprising model-model similarity storage means for storing language model-language model similarities for the language models,
wherein the topic estimation means uses, as a criterion of the depth of a hierarchy of a topic, a similarity between a language model belonging to the hierarchy of the topic and a language model in a higher hierarchy than the hierarchy of the topic.

5. The speech recognition apparatus according to claim 4,
wherein the topic estimation means selects the language models based on the language models used when the tentative recognition result is obtained.

6. The speech recognition apparatus according to claim 3,
wherein the topic adaptation means decides a mixing coefficient during mixture of topic-specific language models based on the linear sum.

7. A speech recognition apparatus comprising:
hierarchical language model storage means for storing a plurality of language models structured hierarchically;
text-model similarity calculation means for calculating a similarity between a tentative recognition result for an input speech and each of the language models;
model-model similarity storage means for storing language model-language model similarities for the respective language models;
topic estimation means for selecting at least one of the hierarchical language models based on the similarity between the tentative recognition result and each of the language models, the language model-language model similarities, and a depth of a hierarchy to which each of the language models belongs; and
topic adaptation means for mixing up the language models selected by the topic estimation means, and for creating one language model.

8. The speech recognition apparatus according to claim 7,
wherein the topic estimation means selects the language models based on a threshold determination in respect of: the similarity between the tentative recognition result and each of the language models; the language model-language model similarities; and the depth of each hierarchy to which each of the language models belongs.

9. The speech recognition apparatus according to claim 7,
wherein the topic estimation means selects the language models based on a threshold determination in respect of a linear sum of: the similarity between the tentative recognition result and each of the language models; the language model-language model similarities; and the depth of each hierarchy to which each of the language models belongs.

10. The speech recognition apparatus according to claim 8,
wherein the topic estimation means selects the language models based on the language models used when the tentative recognition result is obtained.

11. The speech recognition apparatus according to claim 7,
wherein the topic estimation means uses, as a criterion of the depth of a hierarchy of a topic, a similarity between a language model belonging to the hierarchy of the topic and a language model in a higher hierarchy than the hierarchy of the topic.

12. The speech recognition apparatus according to claim 9,
wherein the topic adaptation means decides a mixing coefficient during mixture of the language models based on the linear sum.

13. A speech recognition method comprising:
a referring step of referring to hierarchical language model storage means for storing a plurality of language models structured hierarchically;
a text-model similarity calculation step of calculating a similarity between a tentative recognition result for an input speech and each of the language models;
a recognition result confidence score calculation step of calculating a confidence score of the recognition result;
a topic estimation step of selecting at least one of the language models based on the similarity, the confidence score, and a depth of a hierarchy to which each of the language models belongs; and
a topic adaptation step of mixing up the language models selected at the topic estimation step, and of creating one language model.

14. The speech recognition method according to claim 13,
wherein at the topic estimation step, the language models are selected based on a threshold determination in respect of the similarity, the confidence score, and the depth of each hierarchy.

15. The speech recognition method according to claim 13,
wherein at the topic estimation step, the language models are selects based on a threshold determination in respect of a linear sum of the similarity, a function of the confidence score, and a function of the depth of each hierarchy of a topic.

16. The speech recognition method according to claim 13, further comprising a model-model similarity storage step of storing language model-language model similarities for the language models,
wherein at the topic estimation step, a similarity between a language model belonging to the hierarchy of the topic and a language model in a higher hierarchy than the hierarchy of the topic is used as a criterion of the depth of a hierarchy of a topic.

17. The speech recognition method according to claim 16,
wherein at the topic estimation step, the language models are selected based on the language models used when the tentative recognition result is obtained.

18. The speech recognition method according to claim 15,
wherein at the topic adaptation step, a mixing coefficient during mixture of topic-specific language models is decided based on the linear sum.

19. A speech recognition method comprising:
a hierarchical language model storage step of storing a plurality of language models structured hierarchically;
a text-model similarity calculation step of calculating a similarity between a tentative recognition result for an input speech and each of the language models;
a model-model similarity storage step of storing a language model-language model similarities for the respective language models;
a topic estimation step of selecting at least one of the hierarchical language models based on the similarity between the tentative recognition result and each of the language models, the language model-language model similarities, and a depth of a hierarchy to which each of the language models belongs; and
a topic adaptation step of mixing up the language models selected at the topic estimation step, and of creating one language model.

20. The speech recognition method according to claim 19,
wherein at the topic estimation step, the language models are selected based on a threshold determination in respect of: the similarity between the tentative recognition result and each of the language models; the language model-language model similarities; and the depth of each hierarchy to which each of the language models belongs.

21. The speech recognition method according to claim 19,
wherein at the topic estimation step, the language models are selected based on a threshold determination in respect of a linear sum of: the similarity between the tentative recognition result and each of the language models; the language model-language model similarities; and the depth of each hierarchy to which each of the language models belongs.

22. The speech recognition method according to claim 20,
wherein at the topic estimation step, the language models are selected based on the language models used when the tentative recognition result is obtained.

23. The speech recognition method according to claim 19,
wherein at the topic estimation step, a similarity between a language model belonging to the hierarchy of the topic and a language model in a higher hierarchy than the hierarchy of the topic is used as a criterion of the depth of a hierarchy of a topic.

24. The speech recognition method according to claim 21,
wherein at the topic adaptation step, a mixing coefficient during mixture of the language models is decided based on the linear sum.

25. A speech recognition program for causing a computer to execute a speech recognition method comprising:
a referring step of referring to hierarchical language model storage means for storing a plurality of language models structured hierarchically;
a text-model similarity calculation step of calculating a similarity between a tentative recognition result for an input speech and each of the language models;
a recognition result confidence score calculation step of calculating a confidence score of the recognition result;
a topic estimation step of selecting at least one of the language models based on the similarity, the confidence score, and a depth of a hierarchy to which each of the language models belongs; and
a topic adaptation step of mixing up the language models selected at the topic estimation step, and of creating one language model.

26. The speech recognition program according to claim 25,
wherein at the topic estimation step, the language models are selected based on a threshold determination in respect of the similarity, the confidence score, and the depth of each hierarchy.

27. The speech recognition program according to claim 25,
wherein at the topic estimation step, the language models are selected based on a threshold determination in respect of a linear sum of: the similarity; a function of the confidence score; and a function of the depth of each hierarchy of a topic.

28. The speech recognition program according to claim 25,
wherein the speech recognition method further comprises a model-model similarity storage step of storing language model-language model similarities for the language models, and
at the topic estimation step, a similarity between a language model belonging to the hierarchy of the topic and a language model in a higher hierarchy than the hierarchy of the topic is used as a criterion of the depth of a hierarchy of a topic.

29. The speech recognition program according to claim 28,
wherein at the topic estimation step, the language models are selected based on the language models used when the tentative recognition result is obtained.

30. The speech recognition program according to claim 27,
wherein at the topic adaptation step, a mixing coefficient during mixture of topic-specific language models is decided based on the linear sum.

31. A speech recognition program for causing a computer to execute a speech recognition method comprising:
a hierarchical language model storage step of storing a plurality of language models structured hierarchically;
a text-model similarity calculation step of calculating a similarity between a tentative recognition result for an input speech and each of the language models;
a model-model similarity storage step of storing a language model-language model similarities for the respective language models;
a topic estimation step of selecting at least one of the hierarchical language models based on the similarity between the tentative recognition result and each of the language models, the language model-language model similarities, and a depth of a hierarchy to which each of the language models belongs; and
a topic adaptation step of mixing up the language models selected at the topic estimation step, and of creating one language model.

32. The speech recognition program according to claim 31,
wherein at the topic estimation step, the language models are selected based on a threshold determination in respect of: the similarity between the tentative recognition result and each of the language models; the language model-language model similarities; and the depth of each hierarchy to which each of the language models belongs.

33. The speech recognition program according to claim 31,
wherein at the topic estimation step, the language models are selected based on a threshold determination in respect of a linear sum of: the similarity between the tentative recognition result and each of the language models; the language model-language model similarities; and the depth of each hierarchy to which each of the language models belongs.

34. The speech recognition program according to claim 32,
wherein at the topic estimation step, the language models are selected based on the language models used when the tentative recognition result is obtained.

35. The speech recognition program according to claim 31,
wherein at the topic estimation step, a similarity between a language model belonging to the hierarchy of the topic and a language model in a higher hierarchy than the hierarchy of the topic is used as a criterion of the depth of a hierarchy of a topic.

36. The speech recognition program according to claim 33,
wherein at the topic adaptation step, a mixing coefficient during mixture of the language models is decided based on the linear sum.
